(19) United States
(12) Patent Application Publication
(10) Pub. No.: US 2017/0243116 A1
(43) Pub. Date: Aug. 24, 2017

(54) APPARATUS AND METHOD TO DETERMINE KEYWORDS ENABLING RELIABLE SEARCH FOR AN ANSWER TO QUESTION INFORMATION

(71) Applicant: FUJITSU LIMITED, Kawasaki-shi (JP)

(72) Inventor: Ryuichi Takagi, Nakano (JP)

(73) Assignee: FUJITSU LIMITED, Kawasaki-shi (JP)

(21) Appl. No.: 15/424,378

(22) Filed: Feb. 3, 2017

(30) Foreign Application Priority Data
Feb. 23, 2016 (JP) 2016-032262

(51) Int. Cl. G06N 5/02; G06F 17/30

(52) U.S. Cl. CPC G06N 5/02; G06F 17/30477

(57) ABSTRACT

First question information includes questions about a predetermined subject, and each piece of first answer information, associated with a piece of the first question information, indicates an answer that is responsive to the question indicated by the piece of the first question information. The apparatus updates conversion parameters including correlation values each indicating a degree of a correlation between keywords included in the first question information and the first answer information, by adjusting the correlation values so that the keywords enable a predetermined degree of predicted reliability to search for the first answer information. Upon receiving a new question not included in the first question information, the apparatus determines, based on the updated conversion parameters and first keywords extracted from the new question, second keywords enabling the predetermined degree of predicted reliability, and searches for an answer that is responsive to the new question by using the second keywords.

### CROSS-REFERENCE TO RELATED APPLICATION

This application is based upon and claims the benefit of priority of the prior Japanese Patent Application No. 2016-032262, filed on Feb. 23, 2016, the entire contents of which are incorporated herein by reference.

### FIELD

The embodiment discussed herein is related to apparatus and method to determine keywords enabling reliable search for an answer to question information.

### BACKGROUND

Providers who provide service to users (hereinafter also simply referred to as providers) build and operate business systems (hereinafter, also referred to as information processing systems) suitable for usage purposes in order to provide various kinds of services to the users, for example. When an information processing system receives a question text (hereinafter, also referred to as question information) on the service from a user, for example, the information processing system searches a storage unit, in which answer texts to question texts (hereinafter, also referred to as answer information) are stored, for an answer text to the received question text. The information processing system then transmits the searched-out answer text to the user.

When searching for an answer text as described above, the information processing system segments the received question text into morphs to generate a keyword group including multiple keywords, for example. The information processing system then extracts an answer text that includes a large number of keywords among the keywords in the generated keyword group, from the multiple answer texts stored in the storage unit, for example. This enables the provider to transmit to the user the answer text to the question text received from the user (refer to, for example, Japanese Laid-open Patent Publication Nos. 2007-157006, 2007-219955, 2010-198189, and 2002-297651).

### SUMMARY

According to an aspect of the invention, an apparatus is provided with answer information including information on answers to questions about a predetermined subject, and first question information and first answer information, where the first answer information is included in the answer information, each piece of the first question information indicates a question about the predetermined subject, and each piece of the first answer information is associated with a piece of the first question information and indicates an answer that is responsive to the question indicated by the piece of the first question information. The apparatus updates conversion parameters that include correlation values each indicating a degree of a correlation between keywords included in the first question information and the first answer information, by calculating, for each keyword included in the first question information and the first answer information, a correlation score indicating a degree of predicted reliability of the each keyword to search for a corresponding piece of the answer information, based on the updated conversion parameters, and by adjusting the correlation values so that the calculated correlation score indicates a predetermined range of values for keywords included in the first question information and the first answer information. Upon receiving a new question about the predetermined subject which is not included in the first question information, the apparatus converts, based on the updated conversion parameters, first keywords extracted from the new question to second keywords whose correlation scores are within the predetermined range of values, and searches the answer information for an answer that is responsive to the new question by using the second keywords.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of an information processing system, according to an embodiment;

FIG. 2 is a diagram illustrating an example of searching for answer information, according to an embodiment;

FIG. 3 is a diagram illustrating an example of searching for answer information, according to an embodiment;

FIG. 4 is a diagram illustrating an example of a hardware configuration of an information processing device, according to an embodiment;

FIG. 5 is a diagram illustrating an example of a functional configuration of an information processing device, according to an embodiment;

FIG. 6 is a diagram illustrating an example of an operational flowchart for a search control process, according to an embodiment;

FIG. 7 is a diagram illustrating an example of an operational flowchart for a search control process, according to an embodiment;

FIG. 8 is a diagram illustrating an example of a search control process, according to an embodiment;

FIG. 9 is a diagram illustrating an example of a search control process, according to an embodiment;

FIG. 10 is a diagram illustrating an example of a detailed operational flowchart for a search control process, according to an embodiment;

FIG. 11 is a diagram illustrating an example of a detailed operational flowchart for a search control process, according to an embodiment;

FIG. 12 is a diagram illustrating an example of teacher data, according to an embodiment;

FIG. 13 is a diagram illustrating an example of keywords extracted from first question information and first answer information, according to an embodiment;

FIG. 14 is a diagram illustrating an example of second question information transmitted from a provider terminal, according to an embodiment;

FIG. 15 is a diagram illustrating an example of first keywords before conversion, according to an embodiment;

FIG. 16 is a diagram illustrating an example of conversion parameters, according to an embodiment;

FIG. 17 is a diagram illustrating an example of correlation values between keywords, according to an embodiment;

FIG. 18 is a diagram illustrating an example of second keywords after conversion, according to an embodiment; and

FIG. 19 is a diagram illustrating an example of teacher data, according to an embodiment.

### DESCRIPTION OF EMBODIMENT

The question text received by the aforementioned information processing system has been generated by a person in charge who received a call from the user, for example. Thus, the question text received by the information processing system may not include a keyword appropriate for the search of the answer text, depending on a method of generating the question text or the like. The information processing system, therefore, may not transmit the answer text appropriate for the received question text.

It is preferable to improve the accuracy of search.

Configuration of Information Processing System

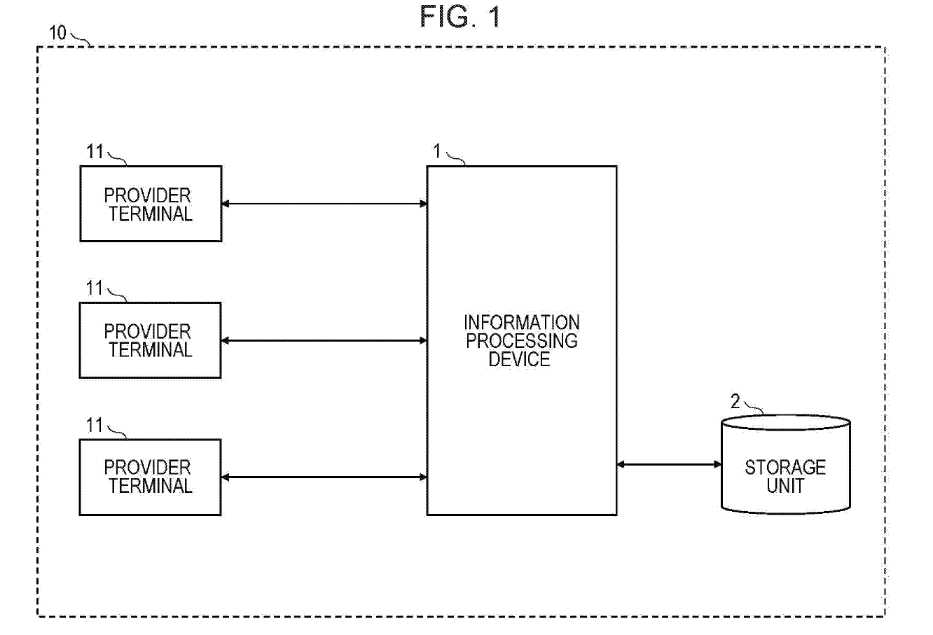

FIG. 1 is a diagram illustrating a configuration of an information processing system 10. The information processing system 10 illustrated in FIG. 1 includes an information processing device 1 (hereinafter, also referred to as search control device 1), a storage unit 2, and multiple provider terminals 11, for example.

When the information processing device 1 receives question information transmitted from the provider terminal 11 that is a terminal used by a provider, the information processing device 1 searches for answer information to the received question information (answer information that includes information for solving a question included in the received question information). The information processing device 1 then transmits the searched-out answer information to the provider terminal 11.

The provider terminals 11 are terminals used by the providers, and each transmit question information to the information processing device 1, for example. Specifically, for example, the provider terminal 11 extracts a part of the content described in an e-mail (for example, e-mail in which a content of inquiry related to a service is described) that is transmitted from a user, and transmits the extracted part of the content as question information to the information processing device 1. Moreover, the provider terminal 11 transmits a content (for example, inquiry content related to a service) inputted by a person in charge who was contacted by phone from a user as question information, to the information processing device 1, for example.

Search for Answer Information

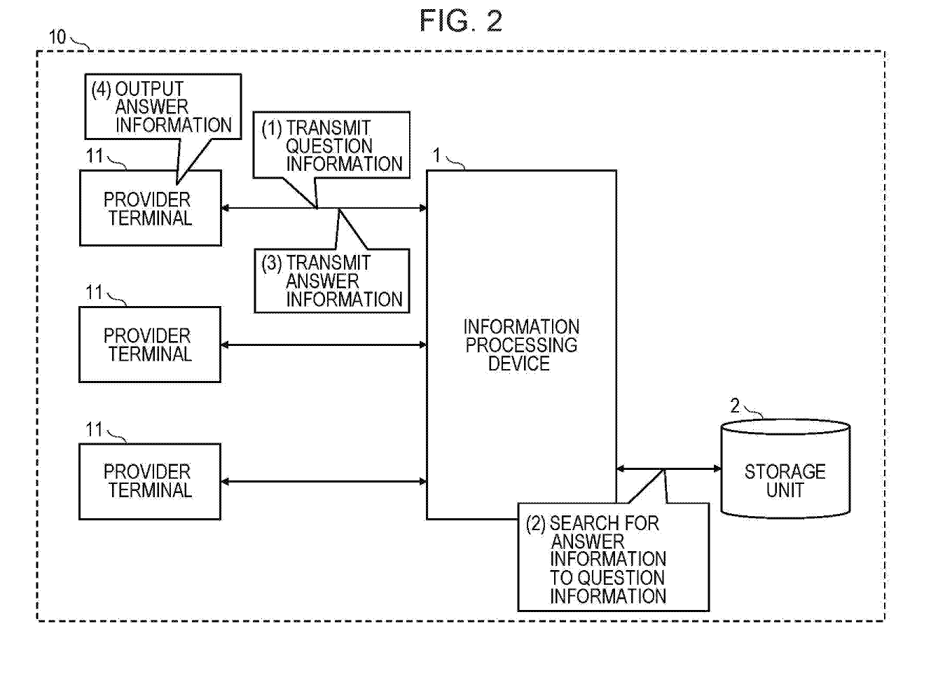

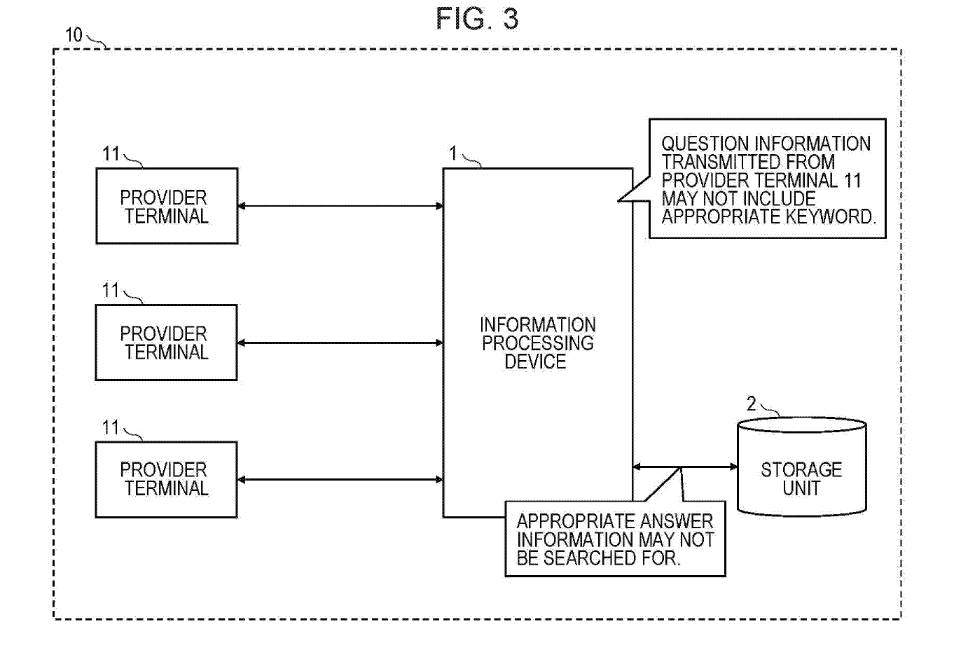

Next, a search for answer information will be described. FIGS. 2 and 3 are diagrams explaining a search for answer information.

As illustrated in FIG. 2, for example, when the provider terminal 11 receives an e-mail transmitted by a user or when a person in charge who was contacted by phone from a user inputs a content of the contact by phone, the provider terminal 11 transmits question information to the information processing device 1 ((1) of FIG. 2).

When the information processing device 1 receives the question information transmitted by the provider terminal 11, the information processing device 1 then searches for answer information to the received question information ((2) of FIG. 2). Specifically, when the information processing device 1 receives question information from the provider terminal 11, the information processing device 1 segments the received question information into morphs to generate a keyword group including multiple keywords, for example. The information processing device 1 then accesses the storage unit 2 that stores therein pieces of answer information to pieces of question information, and extracts a piece(s) of answer information that includes a larger number(s) of keywords among the keywords included in the generated keyword group, for example.

Thereafter, the information processing device 1 transmits the searched-out answer information to the provider terminal 11 ((3) of FIG. 2). The provider terminal 11 then outputs the answer information transmitted from the information processing device 1 to an output device (not illustrated) viewable by the user ((4) of FIG. 2), for example. This enables the user to read the answer information to the content of inquiry having been transmitted or the like.

As described above, the question information received by the information processing device 1 has been generated based on a document generated by the person in charge who received the call from the user, for example. Thus, as illustrated in FIG. 3, the question information received by the information processing device 1 may not include a keyword appropriate for the search of the answer information, depending on a method of generating the question information or the like. Thus, the information processing device 1 may fail to transmit, to the user, the appropriate answer information corresponding to the received question information.

The information processing device 1 according to an embodiment extracts keywords from question information (hereinafter also referred to as first question information) included in teacher data and extracts keywords from answer information (hereinafter also referred to as first answer information) included in the teacher data. Then, the information processing device 1 executes machine learning on conversion parameters for converting the keywords (keyword group) extracted from the first question information into the keywords (keyword group) extracted from the first answer information.

After that, in the search for answer information (hereinafter also referred to as second answer information) corresponding to newly input question information (hereinafter also referred to as second question information), the second answer information is searched using keywords, which are hereinafter also referred to as second keywords after conversion, obtained by converting keywords, which are hereinafter also referred to as first keywords before the conversion, extracted from the newly input question information, based on the conversion parameters subjected to the machine learning.

The provider selects, as the first question information, question information that is likely to be received from the provider terminal 11. In addition, the provider selects, as the first answer information, answer information desirable to be searched for in the search based on the selected first question information. Then, the provider generates the teacher data in which the selected first question information is associated with the selected first answer information.

After that, the information processing device 1 according to the embodiment executes the machine learning on the conversion parameters for converting the keywords extracted from the first question information included in the teacher data into the keywords extracted from the first answer information corresponding to the first question information. Then, the information processing device 1 (or a CPU included in the information processing device 1 in which a machine learning program for executing the machine learning is executed) references the conversion parameters subjected to the machine learning upon the input of the keywords before the conversion that were extracted from the second question information. Then, the information processing device 1 converts the keywords before the conversion into the keywords after the conversion.

Thus, the information processing device 1 may acquire the keywords after the conversion that are used to search the appropriate second answer information in accordance with the association relationship between the first question information selected by the provider and the first answer information selected by the provider. This allows the information processing device 1 to improve the accuracy of the search for the second answer information.

Even if the machine learning is not executed on the same keyword as a keyword before the conversion, the information processing device 1 may estimate keywords after the conversion by using the conversion parameters that have been subjected to the machine learning. Thus, it is unnecessary for the provider to execute the machine learning on all the question information that is likely to be input to the information processing device 1.

Hardware Configuration of Information Processing Device

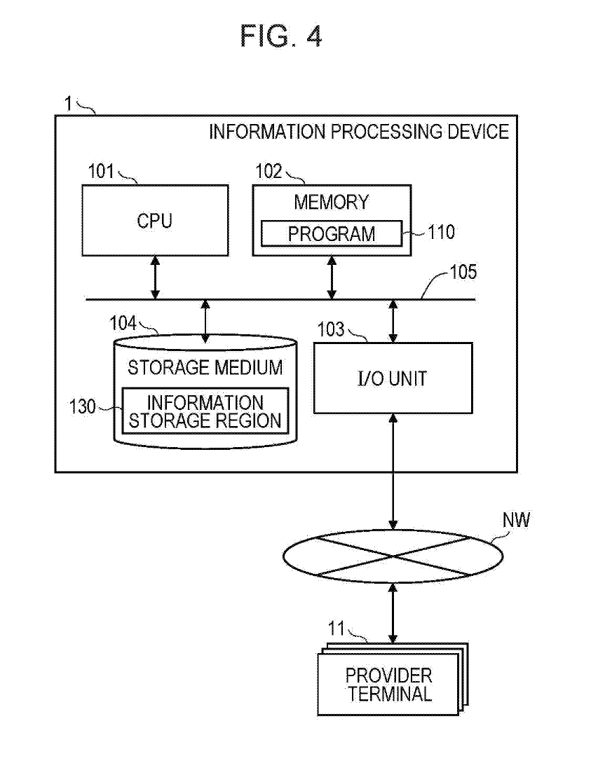

Next, a hardware configuration of the information processing device 1 will be described. FIG. 4 is a diagram illustrating a hardware configuration of the information processing device 1.

The information processing device 1 includes a CPU 101 that is a processor, a memory 102, an external interface (I/O unit) 103, and a storage medium 104. The respective units are coupled to one another via a bus 105.

The storage medium 104 stores, in a program storage region (not illustrated) within the storage medium 104, a program 110 for executing a process (hereinafter also referred to as search control process) of converting the keywords before the conversion into the keywords after the conversion, for example. In addition, the storage medium 104 includes an information storage region 130 (hereinafter also referred to as storage unit 130) for storing information to be used to execute the search control process, for example.

As illustrated in FIG. 4, when the program 110 is executed, the CPU 101 loads the program 110 from the storage medium 104 into the memory 102, and performs the search control processing together with the program 110. Moreover, the external interface 103 communicates with the provider terminals 11 via a network NW including an intranet, the Internet, and others, for example.

Functions of Information Processing Device

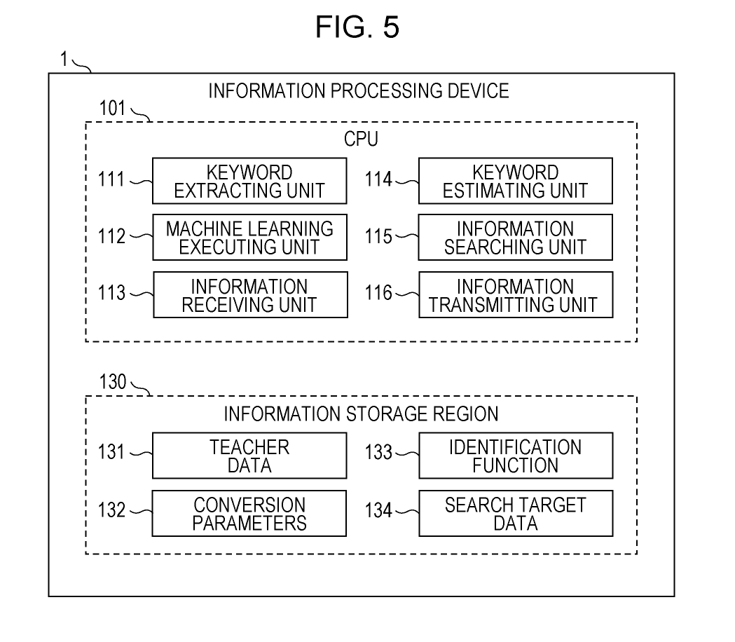

Next, functions of the information processing device 1 are described. FIG. 5 is a functional block diagram of the information processing device 1.

The CPU 101 of the information processing device 1 collaborates with the program 110 and thereby operates as a keyword extracting unit 111 (hereinafter also merely referred to as extracting unit 111), a machine learning executing unit 112, an information receiving unit 113, and a keyword estimating unit 114, for example. In addition, the CPU 101 of the information processing device 1 collaborates with the program 110 and thereby operates as an information searching unit 115 (hereinafter also merely referred to as searching unit 115) and a result output unit 116. Furthermore, teacher data 131, conversion parameters 132, an identification function 133, and search target data 134 are stored in the information storage region 130, for example.

Hereinafter, a case where the teacher data 131 includes first question information 131a and first answer information 131b is described. A region in which the teacher data 131, the conversion parameters 132, and the identification function 133 are stored is hereinafter also referred to as an information storage region 130a, while a region in which the search target data 134 is stored is hereinafter also referred to as an information storage region 130b. The storage unit 2 described with reference to FIG. 1 and the like corresponds to the information storage region 130b, for example.

The keyword extracting unit 111 extracts keywords from the first question information 131a and the first answer information 131b that are included in the teacher data 131 stored in the information storage region 130. Specifically, the keyword extracting unit 111 extracts the keywords by morpheme segmentation of the first question information 131a and the first answer information 131b.

When the information searching unit 115 searches second answer information 141b based on keywords extracted from second question information 141a, the keyword extracting unit 111 extracts keywords from the second question information 141a and extracts keywords from the second answer information 141b. For example, the keyword extracting unit 111 extracts the keywords by morpheme segmentation of the second question information 141a and the second answer information 141b.

The machine learning executing unit 112 executes the machine learning on the conversion parameters 132 for converting keywords extracted from the first question information 131a to keywords extracted from the first answer information 131b.

The machine learning executing unit 112 inputs, as learning data, the keywords extracted from the first question information 131a and the keywords extracted from the first answer information 131b to the identification function 133 and calculates the conversion parameters 132, for example. The identification function 133 is a function that, upon inputting a keyword extracted from question information, outputs, based on the conversion parameters 132, a correlation score indicating a degree of predicted reliability of the keyword to search for the corresponding piece of answer information. When a keyword extracted from the first question information 131a and the conversion parameters 132 are input to the identification function 133, the identification function 133 outputs the correlation score of the keyword, for example. Then, the machine learning executing unit 112 executes the machine learning on the conversion parameters 132 for each of pairs of the keywords extracted from the first question information 131a and the keywords extracted from the first answer information 131b so that the identification function 133 outputs, for all of the keywords included in the first question information and the first answer information, correlation scores that are within a predetermined range of values.

Every time the machine learning executing unit 112 inputs learning data to the identification function 133, the machine learning executing unit 112 adjusts the conversion parameters so that the identification function 133 outputs, for not only learning data (a keyword) input in the past but also the newly input learning data (a keyword), correlation scores within the predetermined range of values. Thus, every time the machine learning executing unit 112 inputs learning data to the identification function 133, the machine learning executing unit 112 may improve the accuracy of the conversion parameters 132. Thus, even if first keywords that are not subjected to the machine learning are input, by a generalization function of the machine learning, the keyword estimating unit 114 may estimate keywords for which the identification function 133 outputs correlation scores within the predetermined range of values, and the keyword estimating unit 114 may output the estimated keywords as the second keywords after the conversion, as described later.

The machine learning executing unit 112 may operate while following an algorithm such as Adaptive Regularization of Weight Vectors (AROW), Confidence Weighted (CW) Learning, or Soft Confidence Weighted (SCW) Learning. The identification function 133 may be determined by the algorithm that the machine learning executing unit 112 follows. In addition, the machine learning executing unit 112 may calculate the conversion parameters 132 by inputting, as learning data, a part of the keywords extracted from the first question information 131a and a part of the keywords extracted from the first answer information 131b to the identification function 133.

The information receiving unit 113 receives second question information 141a that is newly transmitted by the provider terminal 11.

The keyword estimator 114 converts, based on the conversion parameters subjected to the machine learning, first keywords before the conversion that were extracted from the second question information 141a to second keywords after the conversion. Specifically, the keyword estimating unit 114 inputs the first keywords before the conversion and the conversion parameters 132 to the identification function 133 and acquires keywords whose correlation scores are within a predetermined range of values, as the second keywords after the conversion.

The information searching unit 115 uses the second keywords after the conversion that were acquired by the keyword estimating unit 114 and searches for the second answer information 141b corresponding to the second question information 141a. Specifically, the information searching unit 115 searches the search target data 134 including answer information prepared by the provider in advance, for the second answer information 141b. The search target data 134 may include the same answer information as the first answer information 131b included in the teacher data 131.

The information searching unit 115 may search for the second answer information 141b by using only a part of the second keywords after the conversion that were acquired by the keyword estimating unit 114. Specifically, the information searching unit 115 may extract only a keyword with a degree of importance equal to or higher than a predetermined threshold from the second keywords after the conversion and use the extracted keyword for the search of the second answer information 141b.

The provider may determine the number of second keywords to be used for the search of the second answer information 141b in advance. The information searching unit 115 may determine, in descending order of degrees of importance, keywords that are among the second keywords after the conversion and are to be used for the search of the second answer information 141b, for example.

The result output unit 116 transmits the second answer information 141b searched by the information searching unit 115 to the provider terminal 11. Then, the provider terminal 11 outputs the received second answer information 141b to the output device (output device able to be browsed by the user), for example.

### EMBODIMENT

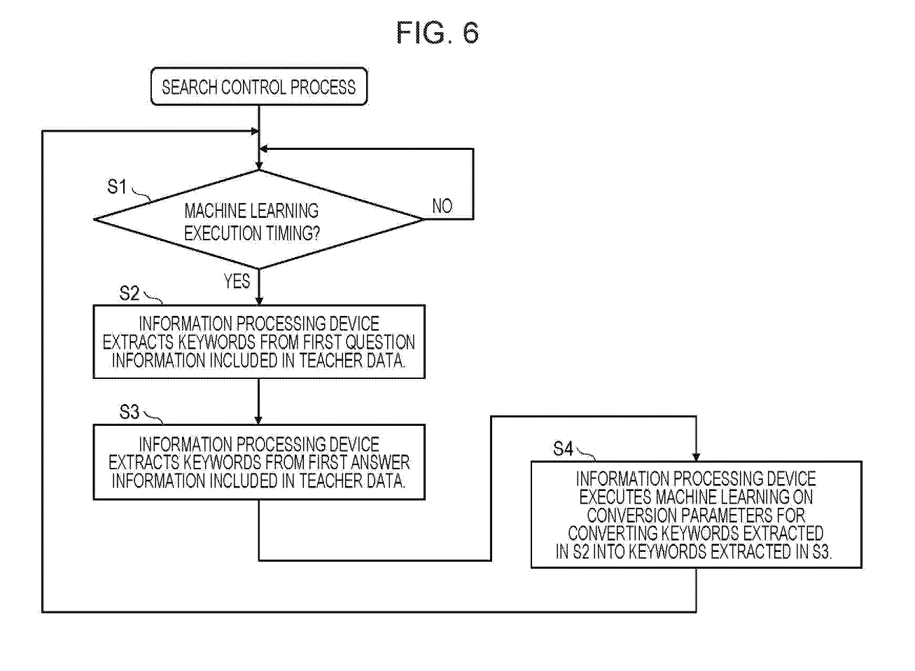

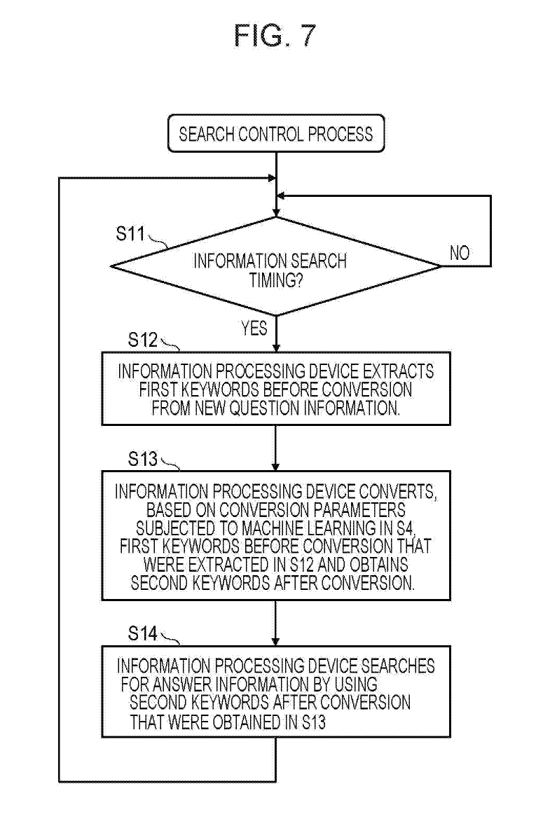

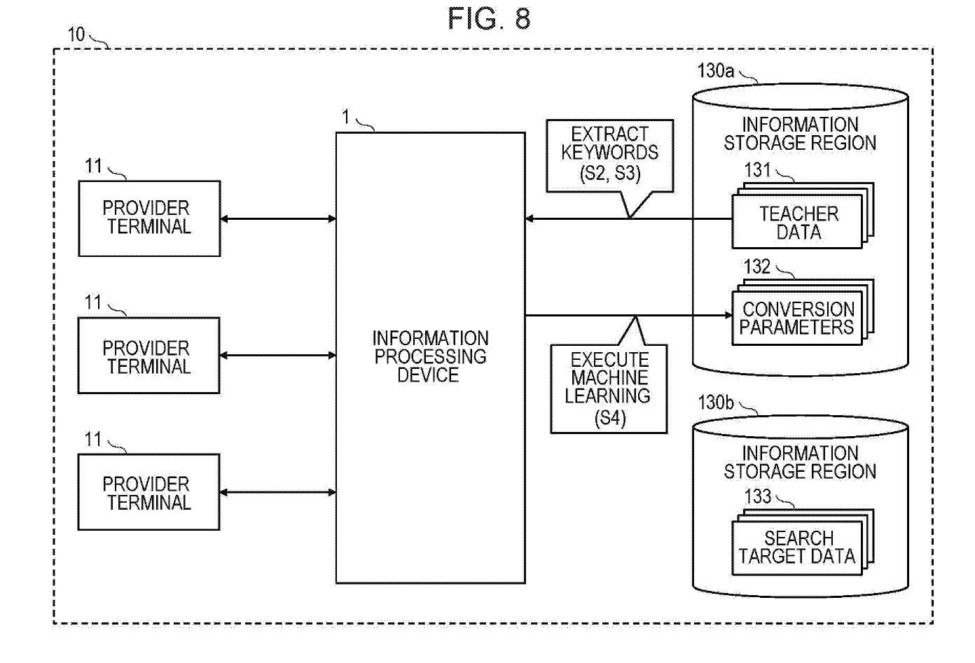

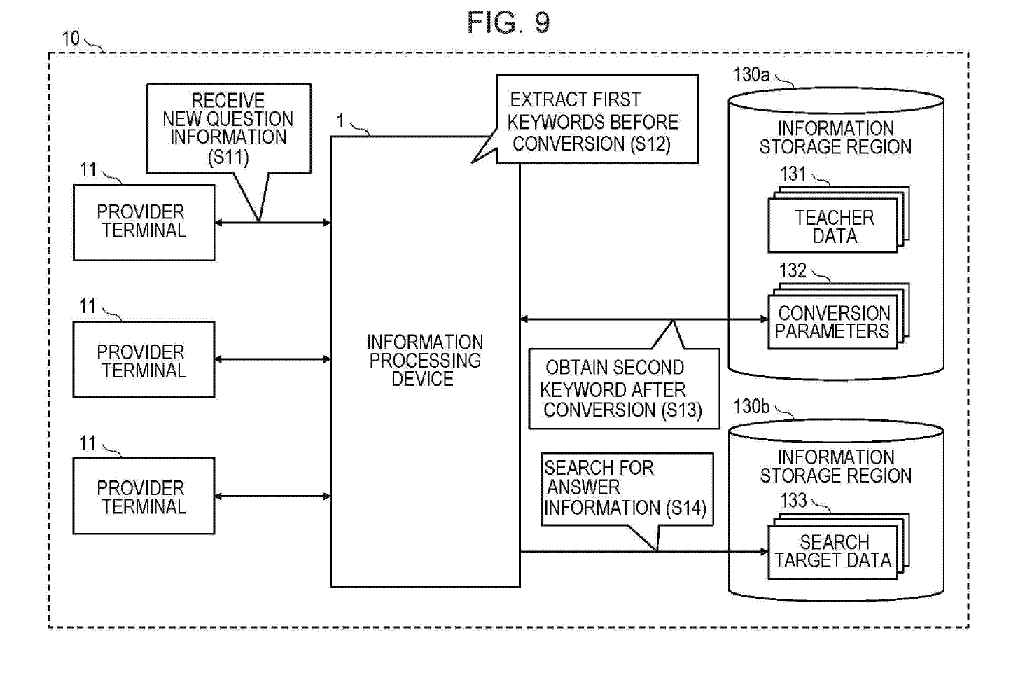

Next, an embodiment is described. FIGS. 6 and 7 are flowcharts illustrating the outline of a search control process according to the embodiment. FIGS. 8 and 9 are diagrams illustrating the outline of the search control process according to the embodiment. The outline of the search control process illustrated in FIGS. 6 and 7 is described with reference to FIGS. 8 and 9.

The information processing device 1 stands by until the current time reaches the time to execute the machine learning (No in S1), as illustrated in FIGS. 6 and 8. The time to execute the machine learning is the time when the provider executes the machine learning on the teacher data 131. The time to execute the machine learning may be the time when the provider inputs information indicating that the machine learning is to be executed on the teacher data 131, for example.

When the current time reaches the time to execute the machine learning (Yes in S1), the information processing device 1 extracts the keywords from the first answer information 131a included in the teacher data 131 (in S2). In addition, the information processing device 1 extracts the keywords from the first answer information 131b included in the teacher data 131 (in S3). Furthermore, the information processing device 1 executes the machine learning on the conversion parameters 132 for converting the keywords extracted in the process of S2 into the keywords extracted in the process of S3 (in S4).

The provider selects, as the first question information 131a, question information likely to be received from the provider terminal 11, for example. When the search is executed based on the selected first question information 131a, the provider selects, as the first answer information 131b, answer information desirable to be selected. Then, the provider generates the teacher data 131 in which the selected first question information 131a is associated with the selected first answer information 131b. Thus, the information processing device 1 may acquire, based on the association relationship between the first question information selected by the provider and the first answer information selected by the provider, the keywords after the conversion that are appropriate for the search of the second answer information, as described later.

The information processing device 1 executes the machine learning on the conversion parameters 132. Thus, even if the machine learning is not executed on the same keyword as a first keyword before the conversion, the information processing device 1 may use the conversion parameters 132 subjected to the machine learning to estimate a second keyword after the conversion corresponding to the first keyword. Thus, it is unnecessary for the provider to perform the machine learning on all the question information 141a likely to be input to the information processing device 1.

After that, the information processing device 1 stands by until the current time reaches the time to search information (No in S11), as illustrated in FIGS. 7 and 9. The time to search the information is the time when the second question information 141a is received from the provider (or the time when the question information 141a is input to the information processing device 1), for example. When the current time reaches the time to search the information (Yes in S11), the information processing device 1 extracts first keywords before the conversion from the second question information 141a (in S12). Furthermore, the information processing device 1 converts, based on the conversion parameters 132 subjected to the machine learning in the process of S4, the first keywords before the conversion that were extracted in the process of S12 into second keywords and thereby obtains the second keywords after the conversion (in S13).

Thus, the information processing device 1 may obtain the second keywords after the conversion that are used in order to appropriately search the second answer information 141b. Thus, the information processing device 1 may improve the accuracy of the search of the second question information 141b.

After that, the information processing device 1 searches the second answer information 141b by using the second keywords after the conversion that were obtained in the process of S13 (in S14).

In this manner, the information processing device 1 according to the embodiment extracts the keywords from the first question information 131a and the first answer information 131b that are included in the teacher data 131. Then, the information processing device 1 executes the machine learning on the conversion parameters 132 for converting the keywords extracted from the first question information 131a into the keywords extracted from the first answer information 131b.

After that, in the search of the second answer information 141b corresponding to the newly input second question information 141a, the information processing device 1 searches, based on the conversion parameters 132 subjected to the machine learning, for the second answer information 141b by using second keywords after the conversion that were obtained by converting first keywords before the conversion that were extracted from the newly input second question information 141a.

Thus, the information processing device 1 may appropriately search the second answer information 141b corresponding to the second question information 141a transmitted from the provider terminal 11.

### DETAILS OF EMBODIMENT

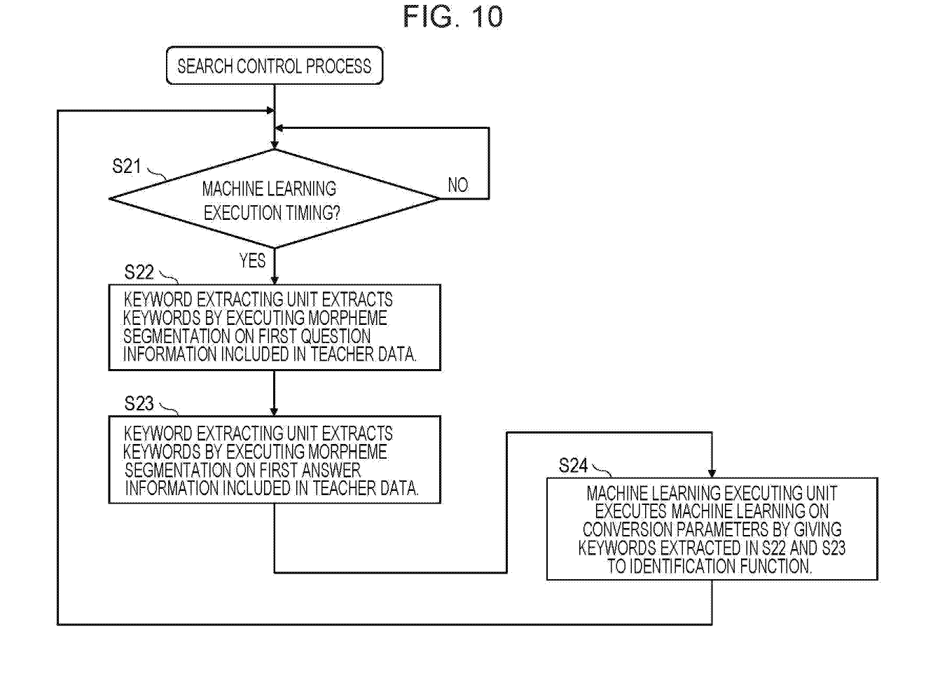

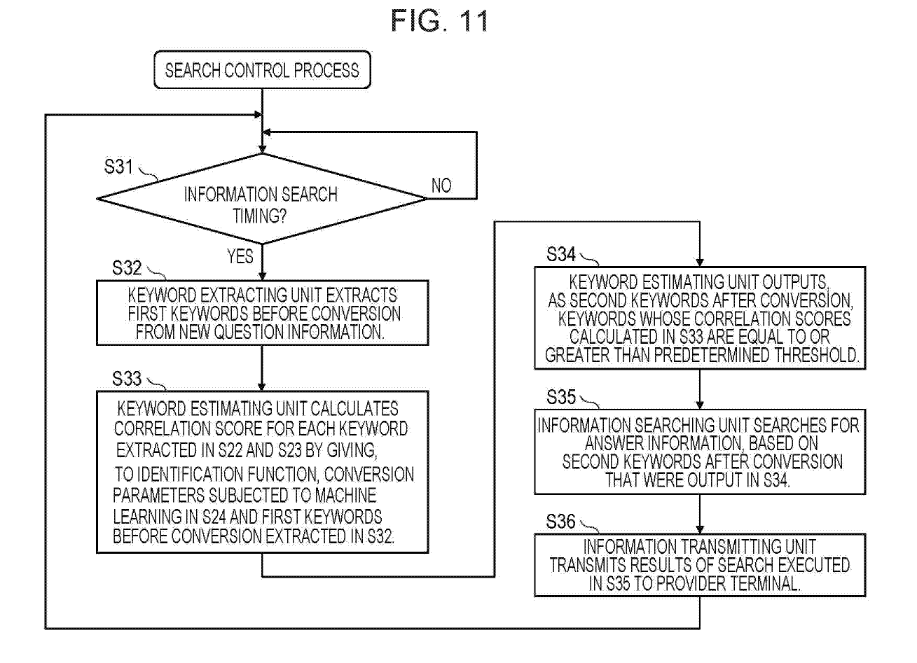

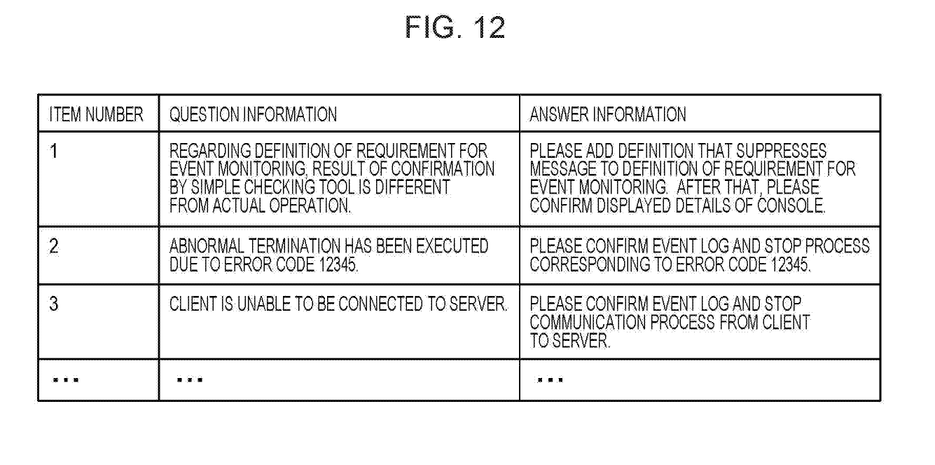

Next, details of the embodiment are described. FIGS. 10 and 11 are flowcharts illustrating details of the search control process according to the embodiment. In addition, FIGS. 12 to 19 are diagrams illustrating the details of the search control process according to the embodiment. The details of the search control process illustrated in FIGS. 10 and 11 are described with reference to FIGS. 12 to 19.

The keyword extracting unit 111 of the information processing device 1 stands by until the current time reaches the time to execute the machine learning (No in S21), as illustrated in FIG. 10. Then, when the current time reaches the time of executing the machine learning (Yes in S21), the keyword extracting unit 111 extracts the keywords from the first question information 131a included in the teacher data 131 (in S22). In this case, the keyword extracting unit 111 extracts the keywords from the first answer information 131b included in the teacher data 131 (in S23). Specifically, the keyword extracting unit 111 extracts the keywords by executing morpheme segmentation on the first question information 131a and the first answer information 131b. A specific example of the teacher data 131 and a specific example of the extracted keywords are described below.

Specific Example of Teacher Data

FIG. 12 is a diagram describing the specific example of the teacher data 131. The teacher data 131 illustrated in FIG. 12 includes an “item number” item identifying the information included in the teacher data 131, a “question information” item in which the first question information 131a is set, and an “answer information” item in which the first answer information 131b is set.

Specifically, in the example illustrated in FIG. 12, in information that is included in the “question information” item and whose “item number” is “1”, a sentence “Regarding the definition of the requirement for the event monitoring, the result of confirmation by the simple checking tool is different from the actual operation.” is set. In the example illustrated in FIG. 12, in information that is included in the “answer information” item and whose “item number” is “1”, sentences “Please add a definition that suppresses the message to the definition of the requirement for the event monitoring. After that, please confirm displayed details of the console.” are set.

In the “question information” item illustrated in FIG. 12, question information expected to be transmitted from the provider terminals 11 is set, for example. In the “answer information” item illustrated in FIG. 12, answer information that includes answers for solving details of the question information set in the “question information” is set. A description of other information illustrated in FIG. 12 is omitted here.

Specific Example of Keywords Extracted from Question Information and Answer Information

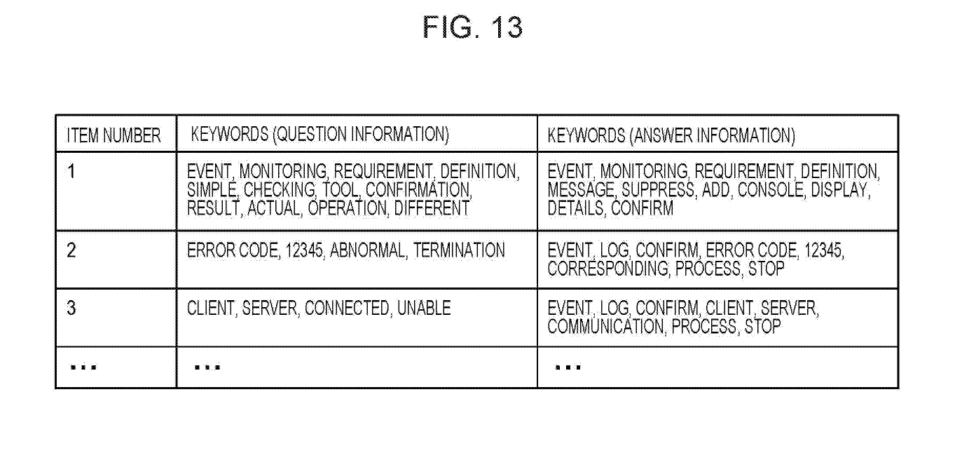

Next, the specific example of the keywords (hereinafter also referred to as keyword information) extracted from the first question information 131a and the first answer information 131b is described. FIG. 13 is a diagram describing the specific example of the keyword information extracted from the first question information 131a and the first answer information 131b.

Keyword information illustrated in FIG. 13 includes an “item number” item identifying information included in the keyword information illustrated in FIG. 13 and a “keywords (question information)” item in which the keywords extracted from the first question information 131a are set. In addition, the keyword information illustrated in FIG. 13 includes a “keywords (answer information)” item in which the keywords extracted from the first answer information 131b are set.

For example, in information that is included in the keyword information illustrated in FIG. 13 and whose “item number” is “1”, “event”, “monitoring”, “requirement”, “definition”, “simple”, “checking”, “tool”, “confirmation”, “result”, “actual”, “operation”, and “different” are set as the “keywords (question information)”. In information that is included in the keyword information illustrated in FIG. 13 and whose “item number” is “1”, “event”, “monitoring”, “requirement”, “definition”, “message”, “suppress”, “add”, “console”, “display”, “details”, and “confirm” are set as the “keywords (answer information)”. A description of other information illustrated in FIG. 13 is omitted.

Return to FIG. 10. The machine learning executing unit 112 of the information processing device 1 executes the machine learning on the conversion parameters 132 by giving, as learning data, the keywords extracted in the process of S22 and the keywords extracted in the process of S23 to the identification function 133 (in S24).

For example, the machine learning executing unit 112 inputs, as the learning data, the keywords extracted in the process of S22 and the keywords extracted in the process of S23 to the identification function 133, and calculates the conversion parameters 132. Then, the machine learning executing unit 112 executes the machine learning on the conversion parameters 132 for each of the pairs of the keywords extracted from the first question information 131a and the keywords extracted from the first answer information 131b, for example.

Every time the machine learning executing unit 112 inputs learning data to the identification function 133, the machine learning executing unit 112 adjusts the conversion parameters 132 so that the identification function 133 is formulated for not only learning data input in the past but also the newly input learning data. Thus, every time the machine learning executing unit 112 inputs learning data to the identification function 133, the machine learning executing unit 112 may improve the accuracy of the conversion parameters 132. Thus, even if a first keyword before conversion that is not subjected to the machine learning by the generalization function of the machine learning is input, the keyword estimating unit 114 may estimate a second keyword after the conversion that corresponds to the first keyword before the conversion. A specific example of the conversion parameters 132 is described later.

The information receiving unit 113 of the information processing device 1 stands by until the current time reaches the time to search information (No in S31), as illustrated in FIG. 11. Then, when the current time reaches the time to search the information (Yes in S31), the keyword extracting unit 111 extracts first keywords before the conversion from the second question information 141a transmitted from the provider terminal 11 (in S32). A specific example of the second question information 141a, and the first keywords before the conversion that are extracted from the second question information 141a, are described below.

Specific Example of Question Information Transmitted from Provider terminal

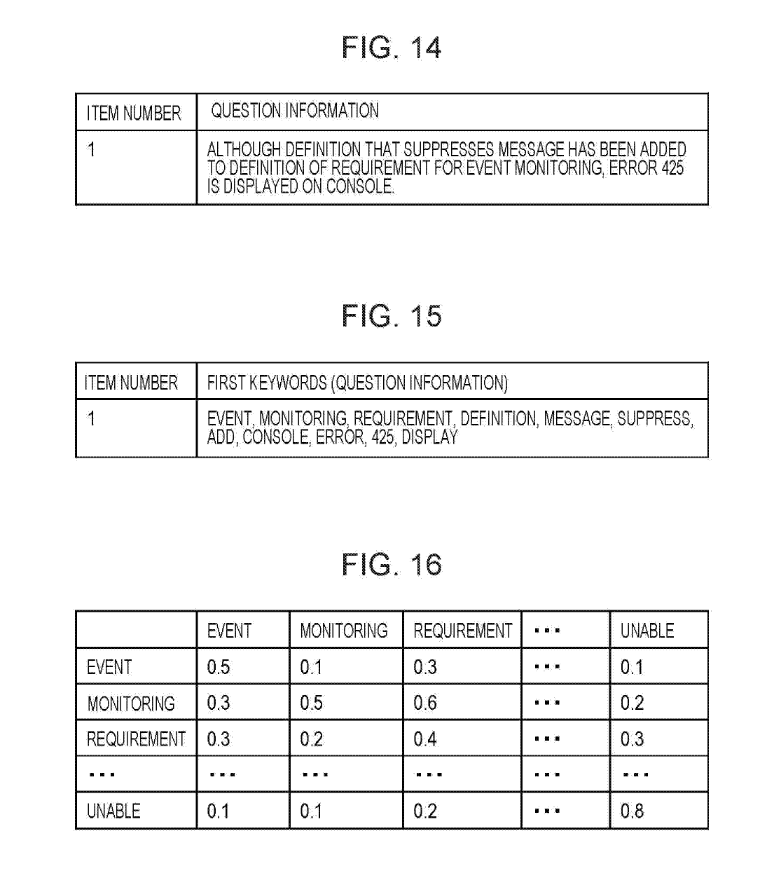

FIG. 14 is a diagram describing the specific example of the second question information 141a transmitted from the provider terminal 11. The second question information 141a illustrated in FIG. 14 includes an “item number” item identifying information included in the second question information 141a and a “question information” item in which details of the second question information 141a are set.

For example, in information that is included in the “question information” item and whose “item number” is “1” in the second question information 141a illustrated in FIG. 14, a sentence “Although the definition that suppresses the message has been added to the definition of the requirement for the event monitoring, an error 425 is displayed on the console.” is set.

Specific Example of First Keywords Before Conversion that are Extracted from Question Information

Next, a specific example of the first keywords (hereinafter also referred to as keyword information before the conversion) before the conversion that are extracted from the second question information 141a transmitted from the provider terminal 11 is described. FIG. 15 is a diagram describing the specific example of the keyword information before the conversion.

Keyword information before the conversion that is illustrated in FIG. 15 includes an “item number” item identifying the information included in the keyword information before the conversion that is illustrated in FIG. 15 and a “keywords (question information)” item in which first keywords extracted from the second question information 141a are set.

For example, in information whose “item number” is “1” and that is included in the keyword information before the conversion that is illustrated in FIG. 15, “event”, “monitoring”, “requirement”, “definition”, “message”, “suppress”, “add”, “console”, “error”, “425”, and “display” are set as the “keywords (question information)”.

Return to FIG. 11. The keyword estimating unit 114 of the information processing device 1 calculates, for each of the keywords extracted from the first question information 131a and the first answer information 131b in the processes of S22 and S23, a correlation score (hereinafter also referred to as correlation information), which indicates a degree of predicted reliability to search for an answer, regarding the first keywords before the conversion that were extracted in the process of S32 (in S33).

For example, the keyword estimating unit 114 gives, to the identification information 133, the first keywords before the conversion that were extracted in the process of S32 and the conversion parameters 132 subjected to the machine learning in the process of S24, and calculates correlation scores (correlation information) regarding the first keywords before the conversion that were extracted in the process of S32. In other words, the keyword estimating unit 114 calculates, for each of keywords extracted from the first question information 131a and the first answer information 131b, a correlation score to be used to determine whether or not the each keyword is to be included in the second keywords after the conversion. Next, a specific example of the conversion parameters 132 and a specific example of the correlation information are described below.

Specific Example of Correlation Information

FIG. 16 is a diagram describing the specific example of the conversion parameters 132. The conversion parameters 132 illustrated in FIG. 16 include correlation values each indicating a degree of a correlation between keywords extracted from the first question information 131a in the process of S22 and the keywords extracted from the first answer information 131b in the process of S23. “Event”, “monitoring”, “requirement”, and the like, which are included in the conversion parameters 132 illustrated in FIG. 16, correspond to the keywords extracted from the first question information 131a in the process of S22 and the keywords extracted from the first answer information 131b in the process of S23.

For example, when “event” is included in the first keywords before the conversion that were extracted from the second question information 141a, the keyword estimating unit 114 references information indicated in a row in which “event” is set in the leftmost column in the process of S33. In addition, when “unable” is included in the first keywords before the conversion that were extracted from the second question information 141a, the keyword estimating unit 114 references information indicated in a row in which “unable” is set in the leftmost column in the process of S33.

Specific Example of Correlation Information

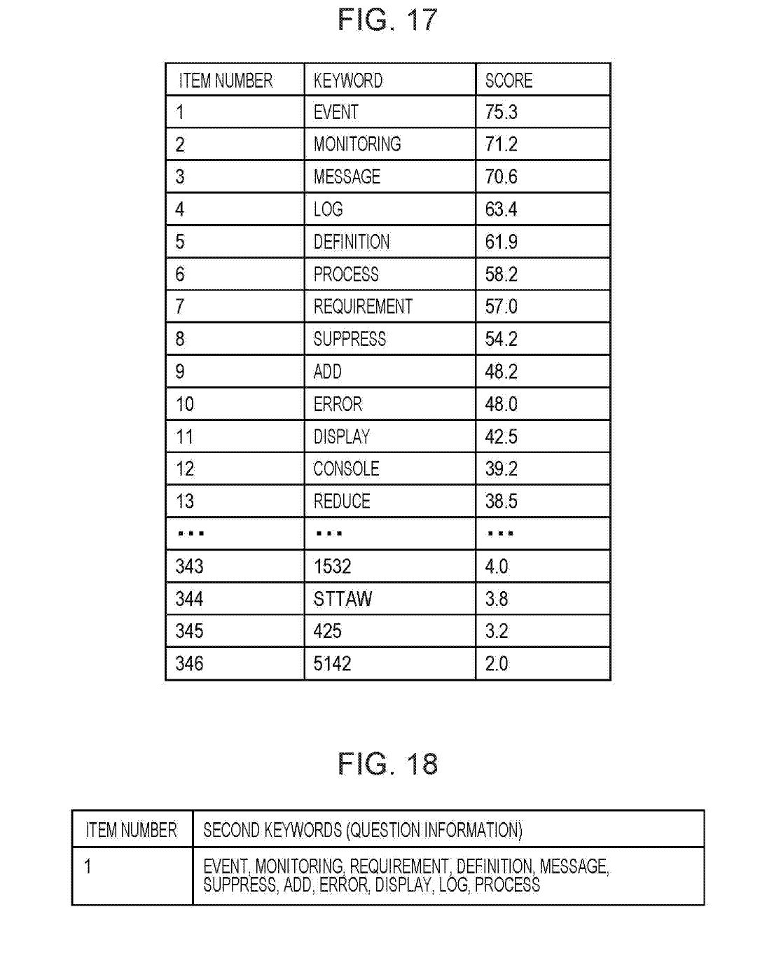

Next, the specific example of correlation information is described. FIG. 17 is a diagram illustrating the specific example of the correlation information. The correlation information illustrated in FIG. 17 includes an “item number” item identifying information included in the correlation information, a “keyword” item identifying the keywords, and a “score” item indicating a degree of predicted reliability of the keywords. It is assumed that the information included in the correlation information illustrated in FIG. 17 is set so that values set in the “score” item are sorted in descending order.

For example, when “event” and “monitoring” are included in the first keywords before the conversion that were extracted from the second question information 141a, the keyword estimating unit 114 references information that is included in the conversion parameters 132 illustrated in FIG. 16 and is indicated in rows in which “event” and “monitoring” are set in the leftmost column. In other words, when calculating a degree of predicted reliability to be used to determine whether or not “requirement” is to be included in the second keywords after the conversion, the keyword estimating unit 114 references “0.3” at the intersection of a row in which “event” is set in the leftmost column and a column in which “requirement” is set in the top row. In this case, the keyword estimating unit 114 also references “0.6” at the intersection of a row in which “monitoring” is set in the leftmost column and a column in which “requirement” is set in the top row. Then, the keyword estimating unit 114 calculates a correlation score corresponding to “requirement” by summing the referenced values “0.3” and “0.6” and multiplying the summed value by a predetermined coefficient.

After that, the keyword estimating unit 114 sets the correlation score calculated for each of the keywords, as illustrated in FIG. 17. The keyword estimating unit 114 sets the calculated correlation score “75.3” in a “score” corresponding to the keyword “event” (or corresponding to the item number “1”), for example. A description of other information illustrated in FIG. 17 is omitted.

Return to FIG. 11. The keyword estimating unit 114 outputs, as second keywords after the conversion, keywords whose correlation score calculated in the process of S33 is equal to or greater than a predetermined threshold (in S34). A specific example of the second keywords (hereinafter also referred to as keyword information after the conversion) after the conversion is described below.

Specific Example of Second Keywords After Conversion

FIG. 18 is a diagram describing the specific example of the second keywords after the conversion. Keyword information after the conversion that is illustrated in FIG. 18 includes the same items as the information illustrated in FIG. 15.

Specifically, when the predetermined threshold used in the process of S34 is “40.0”, the keyword estimating unit 114 determines, as the second keywords after the conversion, keywords set in the “keyword” item and corresponding to item numbers “1” to “11” of the “item number” item within the correlation information illustrated in FIG. 17. In this case, the keyword estimating unit 114 sets, as the second keywords, “event”, “monitoring”, “message”, “log”, “definition”, “process”, “requirement”, “suppress”, “add”, “error”, and “display”, to the “keywords (question information)” item, as indicated by the second keywords after the conversion that is illustrated in FIG. 18.

In the information set in the “keyword” item and corresponding to the item numbers “1” to “11” of the “item number” item within the correlation information illustrated in FIG. 17, “process” and “log”, which are not included in first keywords indicated by the “first keywords (question information)” item described with reference to FIG. 15 and indicating the first keywords before the conversion, are included. Thus, the keyword estimating unit 114 determines “process” and “log” as the second keywords after the conversion, as illustrated in FIG. 18.

In the information set in the “keyword” item and corresponding to the item numbers “1” to “11” of the “item number” item within the correlation information illustrated in FIG. 17, “console” and “425”, which are included in first keywords indicated by the “first keywords (question information)” item described with reference to FIG. 15 and indicating the first keywords before the conversion, are not included. Thus, the keyword estimating unit 114 does not determine “console” and “425” as second keywords after the conversion, as illustrated in FIG. 18.

Thus, the information processing device 1 may appropriately search for the second answer information 141b corresponding to the second question information 141a transmitted from the provider terminal 11.

In the process of S34, the keyword estimating unit 114 may be configured to identify keywords (hereinafter also referred to as keywords to be deleted) that are not included in the keywords, among the first keywords before the conversion that were extracted in the process of S32, whose correlation scores calculated in the process of S33 are equal to or greater than the predetermined threshold. Then, the keyword estimating unit 114 may determine, as the second keywords after the conversion, keywords that are among the first keywords before the conversion and are not included in the keywords to be deleted.

Alternatively, in the process of S34, the keyword estimating unit 114 may be configured to identify keywords (hereinafter also referred to as keywords to be added) that are among the keywords whose correlation scores calculated in the process of S33 are equal to or greater than the predetermined threshold and are not included in the first keywords before the conversion that were extracted in the process of S32. Then, the keyword estimating unit 114 may determine, as the second keywords after the conversion, keywords that include the first keywords before the conversion and the keywords to be added.

Return to FIG. 11. The information searching unit 115 of the information processing device 1 searches for the second answer information 141b by using the second keywords after the conversion that were output in the process of S34 (in S35). Then, the result output unit 116 of the information processing device 1 transmits the results (second answer information 141b) of the search executed in the process of S35 to the provider terminal 11 (in S36). Thus, the provider terminal 11 may output the searched second answer information 141b to the output device that is browsable by the user who has sent the mail or the like to the provider terminal 11.

In this manner, the information processing device 1 according to the embodiment extracts keywords from the first question information 131a and the first answer information 131b that are included in the teacher data 131. Then, the information processing device 1 executes the machine learning on the conversion parameters 132 so that the keywords extracted from the first question information 131a are converted, based on the conversion parameters 132, to the keywords extracted from the first answer information 131b.

After that, in the search of the second answer information 141b corresponding to the newly input second question information 141a, the information processing device 1 searches for the second answer information 141b by using the second keywords after the conversion which are obtained by converting, based on the conversion parameters 132 subjected to the machine learning, the first keywords before the conversion extracted from the new second question information 141a.

Thus, when receiving the second question information 141a from the provider terminal 11, the information processing device 1 may search for the second answer information 141b with high accuracy.

Another Specific Example of Teacher Data

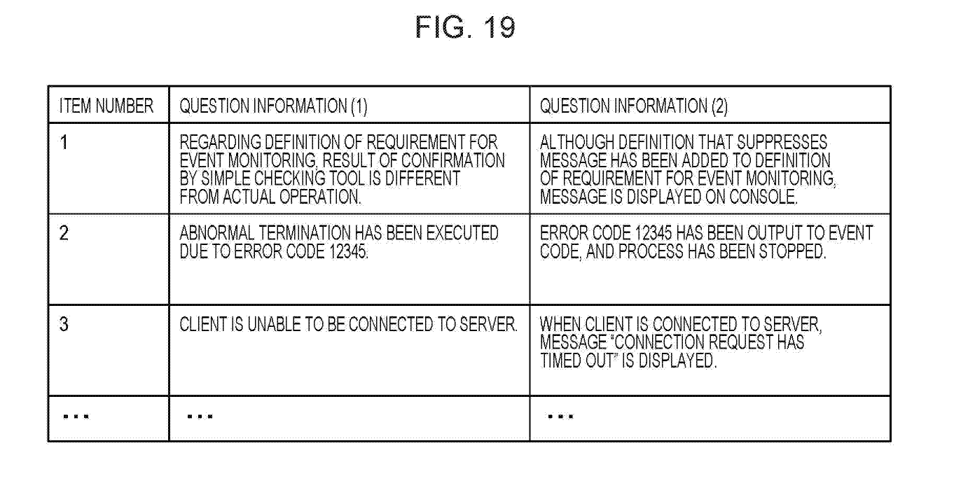

Next, another specific example of the teacher data 131 is described. FIG. 19 is a diagram describing the specific example of the teacher data 131.

The teacher data 131 illustrated in FIG. 19 includes an “item number” item identifying each information included in the teacher data 131 and a “question information (1)” item in which the first question information 131a is set. In addition, the teacher data 131 illustrated in FIG. 19 includes a “question information (2)” item in which question information 131c that includes keywords enabling the first answer information 131b to be more appropriately searched than the first question information 131a is set.

In the example illustrated in FIG. 19, in information at the intersection of the “question information (1)” item and a row whose “item number” is “1”, the sentence “Regarding the definition of the requirement for the event monitoring, the result of the confirmation by the simple checking tool is different from the actual operation.” is set. In the example illustrated in FIG. 19, in information at the intersection of the “question information (2)” item and a row whose “item number” is “1”, a sentence “Although the definition that suppresses the message has been added to the definition of the requirement for the event monitoring, the message is displayed on the console.” is set.

In the example described with reference to FIG. 12 and the like, the teacher data 131 includes the first question information 131a and the second answer information 131b, and the information processing device 1 executes the machine learning on the conversion parameters 132, based on keywords that have been extracted from the first question information 131a and the first answer information 131b. On the other hand, the teacher data 131 illustrated in FIG. 19 includes the first question information 131a and the question information 131c that includes keywords enabling the first answer information 131b to be more appropriately searched than the first question information 131a. The information processing device 1 executes the machine learning on the conversion parameters 132, based on keywords that have been extracted from the first question information 131a and the question information 131c.

Thus, the information processing device 1 may executes the machine learning on the conversion parameters 132, by properly using the teacher data 131 described with reference to FIG. 12 or the teacher data 131 illustrated in FIG. 19 depending on characteristics of the keywords included in the second question information 141a and the second answer information 141b, for example. Thus, the information processing device 1 may search for, with high accuracy, the second answer information 141b for the second question information 141a transmitted from the provider terminal 11.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process comprising:
providing answer information including information on answers to questions about a predetermined subject;
providing first question information and first answer information, the first answer information being included in the answer information, each piece of the first question information indicating a question about the predetermined subject, each piece of the first answer information being associated with a piece of the first question information and indicating an answer that is responsive to the question indicated by the piece of the first question information;
updating conversion parameters that include correlation values each indicating a degree of a correlation between keywords included in the first question information and the first answer information, by:
calculating, for each keyword included in the first question information and the first answer information, a correlation score indicating a degree of predicted reliability of the each keyword to search for a corresponding piece of the answer information, based on the updated conversion parameters, and
adjusting the correlation values so that the calculated correlation score indicates a predetermined range of values for keywords included in the first question information and the first answer information; and
upon receiving a new question about the predetermined subject which is not included in the first question information, determining, based on the updated conversion parameters and first keywords extracted from the new question, second keywords as keywords whose correlation scores are within the predetermined range of values, and searching the answer information for an answer that is responsive to the new question by using the second keywords.

2. The non-transitory, computer-readable recording medium of claim 1, wherein
the updating the conversion parameters is performed by executing machine learning on the correlation values, by using, as learning data, keywords extracted from the first question information and keywords extracted from the first answer information.

3. The non-transitory, computer-readable recording medium of claim 2, wherein
the updating the conversion parameters is performed by executing machine learning on the correlation values, by using, as learning data, a part of keywords extracted from the first question information and a part of keywords extracted from the first answer information.

4. The non-transitory, computer-readable recording medium of claim 1, wherein
the determining the second keywords includes:
calculating, for each of keywords extracted from the first question information and the first answer information, the correlation score regarding the first keywords, and
determining the second keywords, based on the calculated correlation scores.

5. The non-transitory, computer-readable recording medium of claim 4, wherein
the predetermined range of values is a range of values that are equal to or greater than a predetermined threshold.

6. The non-transitory, computer-readable recording medium of claim 4, wherein
the determining the second keywords is performed by:
identifying third keywords that are included in the first keywords and are not included in keywords whose degree of predicted reliability is equal to or greater than the predetermined threshold, and
determining the second keywords as keywords that are included in the first keywords and not included in the third keywords.

7. The non-transitory, computer-readable recording medium of claim 4, wherein
the determining the second keywords is performed by:
identifying third keywords that are not included in the first keywords and whose degree of predicted reliability is equal to or greater than the predetermined threshold, and
determining the second keywords as keywords that are included in the first keywords or the third keywords.

8. The non-transitory, computer-readable recording medium of claim 1, wherein
the searching the answer information is performed by using a part of the second keywords.

9. An apparatus comprising:
a memory configured to store:
answer information including information on answers to questions about a predetermined subject, and
first question information and first answer information, the first answer information being included in the answer information, each piece of the first question information indicating a question about the predetermined subject, each piece of the first answer information being associated with a piece of the first question information and indicating an answer that is responsive to the question indicated by the piece of the first question information; and
a processor coupled to the memory and configured to:
update conversion parameters that include correlation values each indicating a degree of a correlation between keywords included in the first question information and the first answer information, by:
calculating, for each keyword included in the first question information and the first answer information, a correlation score indicating a degree of predicted reliability of the each keyword to search for a corresponding piece of the answer information, based on the updated conversion parameters, and
adjusting the correlation values so that the calculated correlation score indicates a predetermined range of values for keywords included in the first question information and the first answer information; and
upon receiving a new question about the predetermined subject which is not included in the first question information, determine, based on the updated conversion parameters and first keywords extracted from the new question, second keywords as keywords whose correlation scores are within the predetermined range of values, and search the answer information for an answer that is responsive to the new question by using the second keywords.

10. A method comprising:
providing answer information including information on answers to questions about a predetermined subject;
providing first question information and first answer information, the first answer information being included in the answer information, each piece of the first question information indicating a question about the predetermined subject, each piece of the first answer information being associated with a piece of the first question information and indicating an answer that is responsive to the question indicated by the piece of the first question information;
updating conversion parameters that include correlation values each indicating a degree of a correlation between keywords included in the first question information and the first answer information, by:
calculating, for each keyword included in the first question information and the first answer information, a correlation score indicating a degree of predicted reliability of the each keyword to search for a corresponding piece of the answer information, based on the updated conversion parameters, and
adjusting the correlation values so that the calculated correlation score indicates a predetermined range of values for keywords included in the first question information and the first answer information; and
upon receiving a new question about the predetermined subject which is not included in the first question information, determining, based on the updated conversion parameters and first keywords extracted from the new question, second keywords as keywords whose correlation scores are within the predetermined range of values, and searching the answer information for an answer that is responsive to the new question by using the second keywords.
